(19) United States
(12) Patent Application Publication
(10) Pub. No.: US 2019/0213797 A1
(43) Pub. Date: Jul. 11, 2019

(54) HYBRID HAND TRACKING OF PARTICIPANTS TO CREATE BELIEVABLE DIGITAL AVATARS

(71) Applicant: Unchartedvr Inc., San Rafael, CA (US)

(72) Inventor: Douglas Griffin, Mill Valley, CA (US)

(21) Appl. No.: 16/241,540

(22) Filed: Jan. 7, 2019

Related U.S. Application Data
(60) Provisional application No. 62/614,467, filed on Jan. 7, 2018.
(60) Provisional application No. 62/614,469, filed on Jan. 7, 2018.

(51) Int. Cl. G06T 19/20; G06T 15/20; G06T 13/40; G06F 3/01; G06K 9/00; G01S 17/89

(52) U.S. Cl. CPC G06T 19/20; G06T 15/205; G06T 13/40; G01S 17/89; G06K 9/00335; G06F 3/011; G06K 9/00369; G06F 3/017

(57) ABSTRACT

A system is described for providing an enhanced virtual reality experience (VR) for players. The system comprises both fixed and mobile tracking systems, a merged reality processor, and VR engines. A plurality of cameras are mounted over and along a perimeter of a stage. The cameras track the players' movements and generate real-time positional data of each player on the stage. Player-mounted tracking systems produce data tracking movements of the players' arms, hands, and fingers. The merged reality processor compiles a most accurate set of tracking data from the positional data and the tracking data, wherein the merged reality processor detects whether the tracking data is ambiguous. The VR engines use the selected sets of data from the motion tracking system and the head-mounted tracking systems to generate realistic VR representations of the players' arms, hands, and fingers that correspond with the actual position of the players arms, hands, and fingers.

### RELATED APPLICATIONS

This application claims the benefit of U.S. Provisional Patent Application No. 62/614,467, filed Jan. 7, 2018, and U.S. Provisional Patent Application No. 62/614,469, filed Jan. 7, 2018, both of which are incorporated herein by reference for all purposes.

### FIELD OF THE INVENTION

This application relates to virtual reality attractions and, more specifically, to virtual reality attractions that blend physical elements with VR representations.

### BACKGROUND

With the growth of 3D gaming, various companies have developed technology to track people and motions on a set, and then simulate the same motions on avatars created for a 3D virtual world. These technologies suffer two significant problems: (1) erroneous global location of the hand, and (2) occlusion of the hand when engaged with a prop. There is a need for improvements in this technology that will more accurately, or at least more realistically, present the location and of the hand and fingers, even when the hand and/or fingers are obscured from a camera's view.

### SUMMARY

In U.S. patent application Ser. No. 15/828,198, entitled “Method for Grid-Based Virtual Reality Attraction,” which was filed Dec. 7, 2017 and which is herein incorporated by reference for all purposes, a VR attraction is described that blends virtual experiences seen or heard on a headset with real, physical, tactical physical props staged in places that spatially correspond with virtual objects seen in the virtual world. Examples of physical props include a warped wooden plank laid down on the floor, an elevator simulator on the floor that simulates but does not provide real floor-to-floor movement, and a real flashlight and flashlight beam that are virtually represented in the headset.

This application is directed to improvements in the tracking of arms, hands, and fingers of a VR attraction participant (hereinafter, “participant”) so that the virtual representation that is seen through the VR headsets approximately (and convincingly) corresponds with the actual position of the participant's arms, hands, and fingers.

This application introduces a hybrid approach to motion tracking of the arms and hands. First, a stage motion tracking system that monitors motion across the stage is also used to track the forearm. Second, a distinct head-mounted tracking system is used to track wrist and finger movement.

The head-mounted tracking system is proficient at tracking the forearms, hands, and fingers when they are in the camera's field of view. But when a participant drops his/her arms to the side, the shoulders interfere with the tracking of the arms, hands, and fingers. This sometimes results in strange and erratic VR representations of the arms, hands, and fingers. This detracts from the realism of the VR experience.

Combining the data from the head-mounted tracking system with the stage motion tracking system provides a more complete set of motion tracking data, enabling the hybrid system to track the arms even when they are not visible to the head-mounted tracking system. This allows the secondary participant(s) to see natural arm movements on the first participants avatar.

### BRIEF DESCRIPTION OF THE DRAWINGS

It will be appreciated that the drawings are provided for illustrative purposes and that the invention is not limited to the illustrated embodiment. The invention is defined by the claims and may encompass embodiments that combine features illustrated in different drawings; embodiments that omit, modify, or replace some of the features depicted; and embodiments that include features not illustrated in the drawings. Therefore, it should be understood that there is no restrictive one-to-one correspondence between any given embodiment of the invention and any of the drawings

FIG. 1 illustrates a space with VR players with varying arm positions, wherein the VR players are equipped with headset-mounted tracking systems, and the space is equipped with a fixed motion tracking system.

FIG. 2 is a flow chart of a method of providing players with an enhanced VR experience combining data from a fixed motion tracking system with data from a headset-mounted tracking system.

### DETAILED DESCRIPTION

Specific quantities, dimensions, spatial characteristics, compositional characteristics and performance characteristics may be used explicitly or implicitly herein, but such specific quantities are presented as examples only and are approximate values unless otherwise indicated. Discussions and depictions pertaining to these, if present, are presented as examples only and do not limit the applicability of other characteristics, unless otherwise indicated.

In describing preferred and alternate embodiments of the technology described herein, specific terms of art are employed for the sake of clarity or illustration. At times, there may be equivalent or superior terms

The technology described herein, however, is not intended to be limited to a specific terminology so selected, and it is to be understood that each specific element includes all technical equivalents that operate in a similar manner to accomplish similar functions.

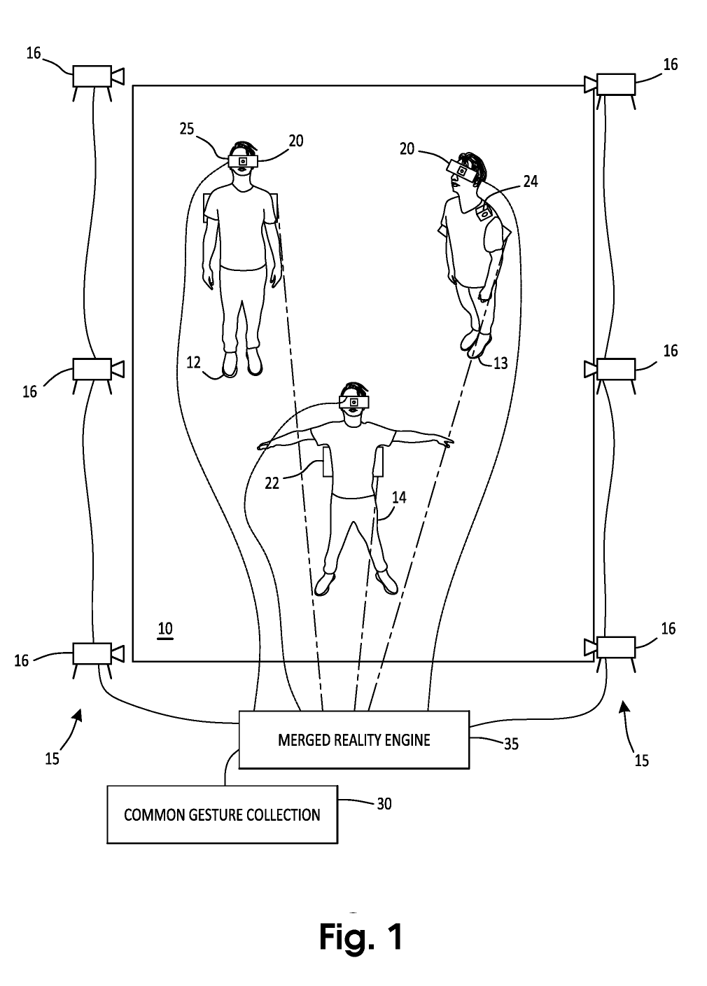

FIG. 1 illustrates a space 10 equipped and configured to provide a VR experience. The space 10 is populated by VR players 12, 13, 14, who are equipped with headset-mounted, shoulder-mounted, and/or back-mounted motion capture systems 25 (aka motion tracking systems). The VR experience comprises a VR “world” in which physical objects and props in the space 10 take on a thematic appearance. The players are depicted as avatars in the VR world.

Overall, the space 10 provides the underlying spatial and textural structure of a VR “world” in which players, physical objects, and props in the space take on a thematic appearance. The VR experience overlays the space 10 with the visual and audio components of the VR “world,” in which physical objects and props in the space 10 take on an audiovisual thematic appearance. The players are depicted as avatars in the VR world.

To provide this experience, the players are equipped with 3D VR engines (processing systems) that may be mounted inside a backpack 22, on a headset 20, or other worn or body-mounted accoutrement. Moreover, each player wears a headset 20 or other accoutrement that includes one or more optical sensors of a player-mounted-or-carried motion tracking system 25.

The player naturally points the head-mounted optical sensor in a direction that is consistent with a straight gaze from the player. By sensing the orientation of the optical sensor—or alternatively of the player's glasses, goggles, headset, or other vision accessory or headgear—each VR engine tracks the location and orientation of the player's visual stance or perspective, and then integrates that information with a 3D model of the virtual world to provide that player with a consistent viewpoint of the virtual world.

In one embodiment, the mobile motion tracking system 25 comprises hardware and software associated with a Leap Motion™ system developed by Leap Motion, Inc., of San Francisco, Calif. The cameras of the mobile motion tracking system 25 are mounted in headsets 20 that are provided for the players 12, 13, 14. The mobile motion tracking systems 25 generate data regarding the players' positions within the space 10 in the form of 6-degrees-of-freedom (6DoF) coordinates that track the movement of retroreflective markers (which reflect light back to the camera with minimal scattering) worn by the players. With information about arm, hand, and finger positions integrated into the construction of a player's avatar, VR players are able to visualize their forearms, hands and fingers, as long as these appendages are visible to the Leap Motion system.

On its own, a motion tracking system such as the Leap Motion™ system can only track the forearms, hands, and fingers when the arms, hands, and fingers when they are visible to it. At times, a portion of a persons' arm or arms will be concealed from the view of the head-mounted camera. A number of positions can conceal the arms from the optical sensors' views, such as when the arms are at rest, when an arm is placed behind the back, or when an arm is reaching around a corner or holding a prop. In the prior art, this resulted in either that portion not being shown or being shown as if that portion was frozen in its last detected position. This results in tracking problems and VR artifacts. Consequently, players in a VR experience see poor, jerky, and strange arm and hand movements on each other's avatars.

Three remedies to this problem are discussed in this application. A fourth remedy is discussed in related U.S. Provisional Patent Application No. 62/614,469. That provisional, along with the nonprovisional of that provisional being filed on the same day as the instant application, are both incorporated herein by reference for all purposes.

The first remedy is to provide one or more cameras 24 that are mounted on the person's arm(s)/shoulder(s) adjacent the upper portion of the humerus just below the scapula. The camera is mounted using an accoutrement worn by the player. The accoutrement may be a shoulder brace—such as shown in any of U.S. Pat. Nos. 472,086, 4,653,893, 5,188,587, and 6,306,111, which are herein incorporated by reference. Or the accoutrement may be a compression garment or brace that that comprises a compression sleeve that wraps around the shoulder and a strap that wraps around the opposite side of the torso, below the armpit or that surrounds both shoulders and covers or crosses the chest. In either case, the camera mount or at least one of the mounts are sewn or otherwise incorporated into the garment, sleeve, or brace at a position just below the scapula to keep the camera generally oriented (i.e., within 20-30°) down the length of the humerus. This way, even as the person moves their arm positions around, the camera (which may be a wide-angle camera) keeps the person's arm and hand within view.

The second remedy is to equip players with inertial measurement units (IMUS) worn on their forearms that measure and report a body's specific force and angular rate. The system detects when the forearm is out of view and uses the IMU data to estimate the position of the forearm. A virtual reality engine uses a motion tree, which is a system of predefined motion poses, to determine a hand pose. For example, when a player's hand comes close to a prop (e.g. door handle), the virtual reality engine selects a pose most closely associated with the prop (e.g., grabbing the door handle) and blends that pose coordinate data with measured player positional data.

The third remedy, which may be either an alternative or addition to the first two remedies, is to equip the space 10 with a fixed motion tracking system 15 comprising a plurality of cameras 16 and optionally other sensors positioned at least along a perimeter of the space 10, and also optionally positioned overhead. One embodiment employs the Optitrack® motion tracking system developed by Optitrack of Corvallis, Oregon. The Optitrack motion tracking system comprises cameras mounted along the sides and ceiling of a play space 10 and Motive™ optical motion tracking software. It is used to track players as well as props. The system generates 6-degrees-of-freedom (6DoF) coordinates to track the movement of the retroreflective markers placed on various objects and worn by the players through the space 10. Image-interpreting software identifies and tracks markers in the images, including the correct global positions of the player's forearm and wrists. In one embodiment, the global coordinates of the markers in the fixed motion tracking images are calculated against one or more references (for example, the known coordinates of one or more of the cameras 16 of the fixed motion tracking system 15) and calibration data that are distinct from the reference(s) (e.g., the known coordinates and orientation of a head-mounted camera) and calibration data utilized to calculate the global coordinates of mobile global capture system images. These calculations are also performed independently of each other. In another embodiment, the mobile and fixed motion tracking systems 25, 15 are unified and the calculations performed by a common system.

In one embodiment, the image-interpreting software is incorporated into the merged reality engine 35. In another, the image-interpreting software is native to the fixed motion tracking system 15, which pre-processes the video data to generate the tracking data, before it is received by the merged reality engine. The software may either share the VR server with the merged reality engine 35, reside on a separate processor, or reside in the cameras 16 themselves.

A data stream from the fixed motion tracking system 15, along with a data stream from the mobile motion tracking system 25, are fed to a merged reality engine (processing system) 35 embodied in a VR server (not shown). In one embodiment, each data stream comprises global coordinates that were pre-calculated by the fixed and mobile motion tracking systems 15, 25. In another embodiment, each data stream comprises raw image data from the cameras of each of the fixed and mobile motion tracking systems 15, 25.

Two streams of marker coordinates (i.e., not mere raw image data) are integrated to create a VR representation of the virtual world that accurately represents the hands and fingers of the players 12, 13, 14. Local position coordinates of the hand and fingers are derived from the mobile motion tracking data. Superimposing the local position coordinates of the hand and fingers to the global forearm coordinates of the forearm and wrist, a virtual hand is realistically grafted onto the virtual forearm and wrist.

In an enhanced embodiment, Leap Motion™ data is combined with fixed motion tracking system data to ensure that portions of the players' arms that are concealed to the Leap Motion™ system are tracked and visualized. This allows the players 12, 13, 14 to see natural arm movements on each other's avatars. Also, in another specific embodiment, a Leap Motion™ optical sensor is mounted on a player's shoulder (just below the scapula), or on both of the player's shoulders, so that the one or two optical sensors each swing with the shoulder it is respectively mounted on, keeping the forearm and hand in the optical sensor's field of view at almost all times.

As noted earlier, the merged reality engine 35 receives and compiles the data generated by the headset-mounted motion tracking systems 25 and the fixed motion tracking system 15. In one embodiment, the merged reality engine 35 utilizes fixed motion tracking data (e.g., coordinates) only for markers that are not already detected by the mobile motion tracking system. In another embodiment, the merged reality engine 35 preferentially selects data (e.g., coordinates) generated by the fixed motion tracking system 15 to represent the positions of the players' body parts within the space. But when retroreflective markers worn on a player's arms, hands, and/or fingers are obscured, then the merged reality engine 35 preferentially selects data generated by the headset-mounted tracking systems to track the positions of the concealed appendages. In yet another alternative embodiment, the merged reality engine 35 detects whether tracking data from the head-mounted tracking systems is ambiguous or insufficiently complete to determine the position and orientation of the arm, hand, and fingers. In one implementation, this determination is based on one or more preset, empirically-derived thresholds. In another implementation, the merged reality processor performs a pattern recognition analysis on the raw image data to ascertain whether 3-D positions of person's arms, hands, and fingers are determinable from the raw image data. In one implementation, the merged reality engine 35 also gives confidence ratings to the tracked markers. If the confidence levels drop below a threshold, then for the corresponding player the merged reality processor 35 selects the data generated by the fixed motion tracking system 15 in place of the tracking data generated by the headset-mounted tracking system to determine the position of the corresponding player's body parts represented by the non-captured or ambiguously captured markers.

As depicted by the dotted lines, the headset-mounted tracking systems wirelessly transmit their data to the merged reality processor 35. As depicted by the solid lines, the fixed motion tracking system 15 transmits its data to the merged reality processor 35 via signal lines connecting the merged reality processor 35 to the fixed motion tracking system 15. As depicted by the dash-dot lines, the merged reality processor 35 wirelessly transmits its compiled data to each player 12, 13, 14, and more particularly, to a backpack-mounted VR engine worn by each player, 12, 13, 14. Each player's VR engine then uses the compiled data to generate VR images that realistically depict the corresponding avatar's arms in positions that correspond to the actual positions of the player's arms.

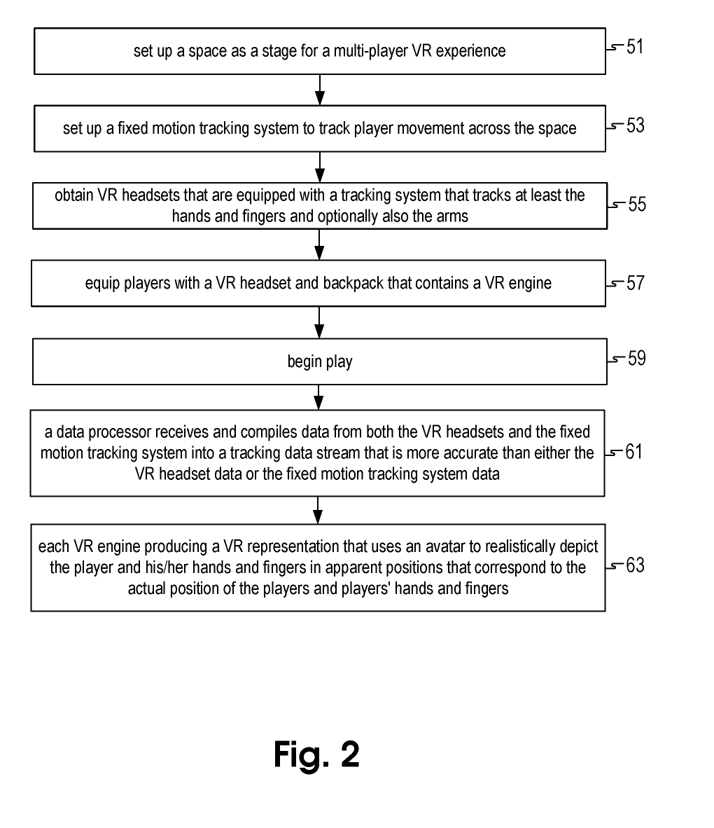

FIG. 2 is a flow chart of a method of providing players with an enhanced VR experience combining data from a fixed motion tracking system 15 with data from a headset-mounted tracking system 25.

In block 51, set up a space as a stage for a multi-player VR experience. In block 53, set up a fixed motion tracking system 15 to track player movement across the space. In block 55, obtain VR headsets that are equipped with a tracking system that tracks at least the hands and fingers and optionally also the arms. In block 57, equip players with a VR headset 20 and backpack that contains a VR engine 22. In block 59, begin play. In block 61, the merged reality processor 35 receives and compiles data from both the VR headsets 20 and the fixed motion tracking system 15, producing a tracking data stream that is more accurate than either the VR headset data or the fixed motion tracking system data. In block 63, each VR engine produces a VR representation that uses an avatar to realistically depict the player and his/her hands and fingers in apparent positions that correspond to the actual position of the players and players' hands and fingers.

In closing, the described “tracking” systems encompass both “outside-in” systems, such as systems employed by Oculus and Vive, and “inside-out” systems using SLAM—Simultaneous Localization And Mapping—that are anticipated to be common on many headsets in the years to come. More narrow characterizations for the described “tracking” systems include “motion capture” systems and “optical motion capture” systems. Furthermore, the invention encompasses systems that combine the innovations described herein with innovations described in the simultaneously-filed, same-inventor application of 62/614,469 entitled “Hybrid Hand and Finger Movement Blending to Create Believable Avatars,” which is herein incorporated by reference for all purposes.

I claim:

1. A system for generating an enhanced virtual reality experience (VR) for a plurality of persons, the system comprising:
a plurality of retroreflective markers, worn by the persons, that are used to track the persons' motion;
a first motion tracking system, comprising a plurality of cameras, configured to be mounted on the persons' heads and to track movements of the arms, hands, and fingers of the respective persons wherein the first motion tracking system generates tracking data of at least one of the persons' arms and hands, when visible to the head-mounted tracking system;
a second motion tracking system, comprising a plurality of cameras mounted at fixed locations, that tracks movements of persons by tracking the movement of the plurality of retroreflective markers across a space, the second motion tracking system also generating a stream of tracking data of each person in the space;
a merged reality processor that compiles a most accurate set of data by selecting from the first motion tracking system's tracking data and the second motion tracking system's tracking data; and
the merged reality processor using the compiled set of tracking data from the first and second motion tracking systems to generate a VR representation of at least one of the person's arms, hands, and fingers that corresponds with the actual position of the at least one of the person's arms, hands, and fingers.

2. The system of claim 1, wherein the tracking data produced by the first motion tracking systems indicate a local position of the persons' arms, hands, and fingers relative to global positions of the persons in the space, and the tracking data produced by the second motion tracking system indicates the global positions of the persons.

3. The system of claim 2, wherein the cameras of the second motion tracking system are mounted over and along a perimeter of the space.

4. The system of claim 3, wherein the second motion tracking system further communicates identity, location and/or orientation information of the persons to the merged reality processor.

5. The system of claim 1, wherein the merged reality processor simulates a virtual reality audiovisual environment with avatars of the persons, which avatars are shown with arm, hand and finger movements that are consistent with the persons' actual arms, hand and finger movements.

6. The system of claim 1, further comprising the merged reality processor detecting whether tracking data from the head-mounted tracking systems is ambiguous or insufficiently complete to determine the position and orientation of the arm, hand, and fingers.

7. The system of claim 1, wherein the merged reality processor performs a pattern recognition analysis on the tracking data to ascertain whether 3-D positions of person's arms, hands, and fingers are determinable from the tracking data.

8. A system for providing an enhanced virtual reality experience (VR), the system comprising:
multiple head-mounted motion tracking systems configured to be worn by participants in a VR experience generated within a space, wherein each of the head-mounted motion tracking systems produces video that includes the participant's hands and fingers provided that the participant's hands and fingers are visible to the head-mounted tracking system;
at least one merged reality processor receiving both the first and second streams, and selecting from each to compile a most accurate set of data from first and second streams;
each participant carrying a VR engine;
wherein each participant's VR engine generates a VR representation of the participant and the participant's arms, hands, and fingers from the most accurate data set.

9. The system of claim 8, further comprising:
physical objects that are staged within the space;
wherein each VR engine simulates a VR audiovisual environment for the participant wearing the VR engine, wherein the VR audiovisual environment depicts the participant with an avatar and depicts virtual objects whose locations and orientations correspond to physical locations of the physical objects within the space;
wherein each VR engine uses tracking information generated by the motion tracking system to present imagery of VR objects as the participant approaches or encounters corresponding physical objects within the space, and to further present imagery of at least the avatar's hands and fingers in positions that correspond to the positions of the participant's hands and fingers.

10. The system of claim 8, further comprising:
a VR headset worn by each participant within the space; and
the VR headset providing each participant a VR representation of the space;
wherein the multi-sensor motion tracking system is mounted on the VR headset.

11. A method of providing an enhanced virtual reality experience (VR) for a participant, the method comprising:
equipping a stage with a fixed motion tracking system that tracks movements of persons across the stage;
the fixed motion tracking system generating positional data of each person on the stage;
each person wearing a head-mounted tracking system that tracks movements of the arms, hands, and fingers of the person, the head-mounted tracking system being distinct from the fixed motion tracking system;
each person's head-mounted tracking system generating relative tracking data of the person's arms, hands, and fingers when the person's arms, hands, and fingers are visible to the head-mounted tracking system, wherein the relative tracking data is relative to a position of the person on the stage;
at least one merged reality processor combining the relative tracking data from the head-mounted tracking system with the positional data from the fixed motion tracking system;
the at least one merged reality processor preferentially selecting the head-mounted tracking system's relative tracking data when that data is substantially complete and unambiguous, the at least one merged reality processor preferentially selecting the motion-tracking system's absolute positional data when the head-mounted tracking system data is not substantially complete and unambiguous; and
a VR engine using the selected sets of data from the motion tracking system and the head-mounted tracking system to generate a VR representation of at least one of the person's arms, hands, and fingers that corresponds with the actual position of at least one of the person's arms, hands.

12. The method of claim 11, wherein the fixed motion tracking system comprises a plurality of cameras that are mounted over and along a perimeter of the stage.

13. The method of claim 11, wherein the fixed motion tracking system comprises a network of sensors configured to track a person's movements on the stage by communicating identity, location and/or orientation information of the person to the merged reality processor.

14. The method of claim 11, further comprising the VR engine simulating a virtual audiovisual environment along with an avatar of the person, wherein the avatar's head, hands, torso, legs, and other features match the person's head, hands, torso, legs, and other features.

15. The method of claim 11, further comprising the at least one merged reality processor detecting whether the relative tracking data from the head-mounted tracking system is substantially complete and unambiguous.

16. The method of claim 15, wherein the at least one merged reality processor performing a pattern recognition analysis on the relative tracking data to ascertain whether 3-D positions of person's arms, hands, and fingers are determinable from the relative tracking data.

17. A method of providing an enhanced virtual reality experience (VR), the method comprising:
tracking movements of at least one person within a space using a multi-sensor motion tracking system;
the multi-sensor motion tracking system generating a first stream of positional data of each person in the space;
each person wearing a head-mounted tracking system, which is distinct from the multi-sensor motion tracking system, that tracks movements of the person's arms, hands, and fingers;
each person's head-mounted tracking system generating a second stream of tracking data of the person's arms, hands, and fingers when the at least one of the person's arms, hands, and fingers are visible to the head-mounted tracking system;
at least one merged reality processor receiving both the first and second streams, and selecting a most accurate set of data from first and second streams;
each person carrying a VR engine;
each person's VR engine generating a VR representation of the person and the person's arms hands and fingers from the most accurate data set.

18. The method of claim 17, further comprising:
staging physical objects within the space;
each VR engine simulating a VR audiovisual environment for the person wearing the VR engine, wherein the VR audiovisual environment depicts the person using an avatar and depicts virtual objects whose locations and orientations correspond to locations and orientations of the physical objects;
wherein each VR representation is configured to use tracking information generated by the motion tracking system to present imagery of VR objects as the person approaches or encounters corresponding stage accessories, and to further present imagery of an avatar's arms, hands, and fingers that correspond to the positions of the person's arms, hands, and fingers.

19. A system for providing an enhanced virtual reality experience (VR) for a player, the system comprising:
a stage equipped with a motion tracking system comprising a plurality of cameras that are mounted over and along a perimeter of the stage, the motion tracking system tracking movements of players across the stage;
the motion tracking system generating positional data of each player on the stage;
a head-mounted tracking system for each player that senses and generates tracking data of the movements of the player's arms, hands, and fingers;
a merged reality processor that compiles a most accurate set of tracking data from the positional data and the tracking data, wherein the merged reality processor detects whether the tracking data is ambiguous;
the merged reality processor selecting the head-mounted tracking system's tracking data when that data is unambiguous;
the merged reality processor selecting the motion-tracking system's positional data when that data is ambiguous; and
a VR engine using the selected sets of data from the motion tracking system and the head-mounted tracking system to generate a VR representation of the person's arms, hands, and fingers that corresponds with the actual position of the person's arms, hands, and fingers.

20. A method of providing an enhanced virtual reality experience (VR) for a person, the method comprising:
equipping a stage with a motion tracking system that tracks movements of persons across the stage, the motion tracking system comprising a plurality of cameras that are mounted over and along a perimeter of the stage;
the motion tracking system generating absolute positional data of each person on the stage;
the person wearing a head-mounted tracking system that tracks movements of the arms, hands, and fingers of the person, the head-mounted tracking system being distinct from the motion tracking system;
the head-mounted tracking system generating relative tracking data of the person's arms, hands, and fingers;
at least one merged reality processor combining the relative tracking data from the head-mounted tracking system with the absolute positional data of the motion tracking system, the at least one merged reality processor detecting whether the relative tracking data from the head-mounted tracking system is ambiguous;
the at least one merged reality processor preferentially selecting the head-mounted tracking system's relative tracking data when that data is unambiguous, the at least one merged reality processor preferentially selecting the motion-tracking system's absolute positional data when the head-mounted tracking system data is ambiguous; and
a VR engine using the selected sets of data from the motion tracking system and the head-mounted tracking system to generate a VR representation of the person's arms, hands, and fingers that corresponds with the actual position of the person's arms, hands.
